(19) United States
(12) Patent Application Publication
(10) Pub. No.: US 2009/0226103 A1
(43) Pub. Date: Sep. 10, 2009

(54) Image encoding apparatus and image decoding apparatus

(75) Inventors: Woong-il Choi, Hwaseong-si (KR); Dae-hee Kim, Suwon-si (KR); Dae-sung Cho, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Gyeonggi-do (KR)

(21) Appl. No.: 12/292,118

(22) Filed: Nov. 12, 2008

(30) Foreign Application Priority Data
Mar. 10, 2008 (KR) 10-2008-0022155

(51) Int. Cl. G06K 9/36

(52) U.S. Cl. 382/233; 382/244

(57) ABSTRACT

Provided are an image encoding apparatus and an image decoding apparatus. The image encoding apparatus includes a prediction encoding unit to perform prediction encoding on an input image so as to generate a residual image, a transform unit to transform the residual image in transform block units so as to generate transform coefficients, a quantization unit to quantize the transform coefficients of a transform block, and an entropy encoding unit to determine a scanning order based on priority at each location of the transform block, to scan the quantized transform coefficients of the transform block in the determined scanning order so as to generate transform coefficients of a one-dimensional array, and to perform entropy encoding on the transform coefficients of the one-dimensional array.

### CROSS-REFERENCE TO RELATED APPLICATIONS

This application claims the benefit of Korean Patent Application No. 10-2008-0022155, filed on Mar. 10, 2008, in the Korean Intellectual Property Office, the disclosure of which is incorporated herein in its entirety by reference.

### BACKGROUND

1. Field

One or more embodiments of the present invention relate to image encoding and decoding, and more particularly, to an image encoding apparatus and an image decoding apparatus, by which entropy coding efficiency of transform coefficients is improved.

2. Description of the Related Art

In general, when a still image or a video image is coded, quantized transform coefficients are arranged by scanning the transform coefficients in a certain pattern and then run-length coding is performed on the arranged transform coefficients. Most image coding standards use a zigzag scanning pattern. The zigzag scanning pattern arranges from low frequency components to high frequency components and thus a low frequency band in which transform coefficients have a high possibility to exist, is firstly scanned. Accordingly, the zigzag scanning pattern is advantageous for run-length coding. After a certain block is completely scanned, information indicating that a given transform coefficient is the last transform coefficient, is provided when entropy coding is performed. Accordingly, the last transform coefficient is rapidly found through a scanning operation and coding efficiency is improved.

In general, an image signal includes a relatively small number of high frequency components and thus when a high frequency component is quantized, the high frequency component has a value 0 in most cases. That is, transform coefficients have a low possibility to exist in a high frequency region and thus, if the zigzag scanning pattern arranging from low frequency components to high frequency components, is used, entropy coding efficiency may be improved by not coding components having a value 0, which mostly exist in the high frequency region. Accordingly, in order to improve the entropy coding efficiency as described above, a scanning order needs to be determined so as to firstly scan a location in which transform coefficients have a low possibility to have a value 0, as long as possible.

### SUMMARY

One or more embodiments of the present invention include an image encoding apparatus and an image decoding apparatus, by which entropy coding efficiency of transform coefficients is improved by adaptively determining a scanning order based on priority of each transform coefficient in accordance with a location.

Additional aspects and/or advantages will be set forth in part in the description which follows and, in part, will be apparent from the description, or may be learned by practice of the invention.

To achieve the above and/or other aspects and advantages, one or more embodiments of the present invention may include an image entropy encoding apparatus including a scanning unit to scan transform coefficients of a transform block in accordance with a scanning order so as to arrange the transform coefficients in a one-dimensional array, a priority coefficient checking unit to check priority of the transform coefficients of the one-dimensional array, a priority correction unit to correct weights of the transform coefficients in accordance with locations, by using the priority checked by the priority coefficient checking unit, and a scanning order determination unit to determine the scanning order from a location having a large weight to a location having a small weight in the transform block, based on the corrected weights.

To achieve the above and/or other aspects and advantages, one or more embodiments of the present invention may include an image entropy decoding apparatus including an inverse scanning unit to inversely scan transform coefficients of a one-dimensional array, which are restored from a bitstream, in accordance with an inverse scanning order so as to generate quantized transform coefficients of a transform block, a priority coefficient checking unit to check priority of the quantized transform coefficients of the transform block, a priority correction unit to correct weights of the transform coefficients in accordance with locations, by using the priority checked by the priority coefficient checking unit, and an inverse scanning order determination unit to determine the inverse scanning order from a location having a large weight to a location having a small weight in the transform block, based on the corrected weights.

To achieve the above and/or other aspects and advantages, one or more embodiments of the present invention may include an image decoding apparatus including an entropy decoding unit to perform entropy decoding on a bitstream so as to restore quantized transform coefficients of a one-dimensional array, to determine an inverse scanning order based on priority at each location of a transform block, and to inversely scan the quantized transform coefficients of the one-dimensional array in the determined inverse scanning order so as to generate quantized transform coefficients of the transform block, an inverse quantization unit to inversely quantize the quantized transform coefficients of the transform block so as to restore transform coefficients of the transform block, an inverse transform unit to inversely transform the transform coefficients of the transform block so as to restore a residual image, and a prediction decoding unit to perform prediction decoding on the residual image so as to generate a reconstructed image.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a structural block diagram of an entropy encoding apparatus according to an embodiment of the present invention;

FIG. 2 is a structural block diagram of an entropy decoding apparatus according to an embodiment of the present invention;

FIG. 3 is a diagram for describing operation of a scanning order determination unit illustrated in FIG. 1, according to an embodiment of the present invention;

FIG. 4 is a diagram for describing operation of the scanning order determination unit illustrated in FIG. 1, according to another embodiment of the present invention;

FIG. 5 is a table for describing a method of setting initial weights to be used by a priority correction unit illustrated in FIG. 1 or FIG. 2;

FIG. 6 is a structural block diagram of an image encoding apparatus according to an embodiment of the present invention;

FIG. 7 is a structural block diagram of an image decoding apparatus according to an embodiment of the present invention;

FIG. 8 is a structural block diagram of an image encoding apparatus according to another embodiment of the present invention; and

FIG. 9 is a structural block diagram of an image decoding apparatus according to another embodiment of the present invention.

### DETAILED DESCRIPTION OF EMBODIMENTS

Reference will now be made in detail to embodiments, examples of which are illustrated in the accompanying drawings, wherein like reference numerals refer to the like elements throughout. In this regard, embodiments of the present invention may be embodied in many different forms and should not be construed as being limited to embodiments set forth herein. Accordingly, embodiments are merely described below, by referring to the figures, to explain aspects of the present invention.

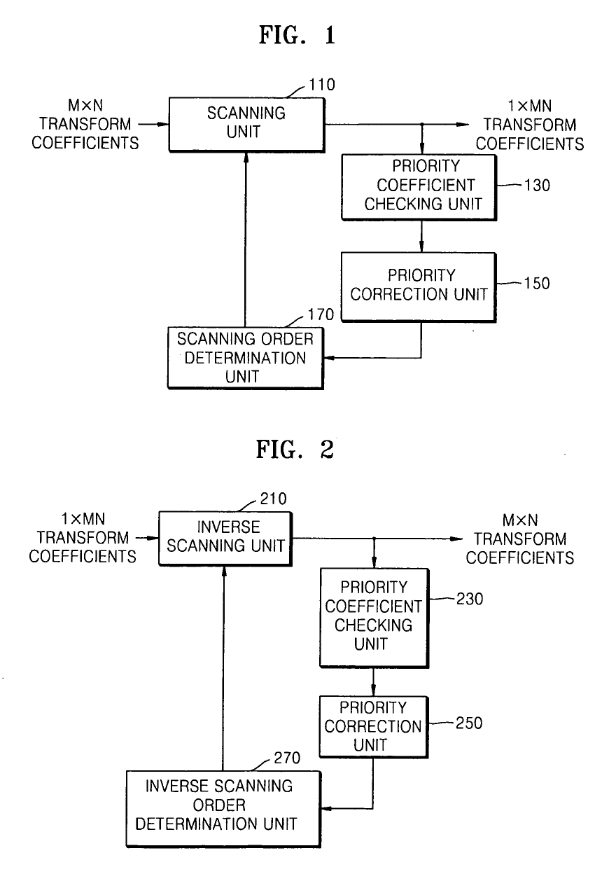

FIG. 1 is a structural block diagram of an image entropy encoding apparatus according to an embodiment of the present invention. The image entropy encoding apparatus illustrated in FIG. 1 includes a scanning unit 110, a priority coefficient checking unit 130, a priority correction unit 150, and a scanning order determination unit 170. Here, the scanning unit 110, the priority coefficient checking unit 130, the priority correction unit 150, and the scanning order determination unit 170 may be implemented as at least one processor.

Referring to FIG. 1, the scanning unit 110 scans transform coefficients of a current M×N block in accordance with a scanning order determined by the scanning order determination unit 170, with reference to previous M×N blocks, so as to arrange the transform coefficients in a one-dimensional array having a size of 1×MN. The transform coefficients arranged in the one-dimensional array are used to perform run-length encoding. Here, the transform coefficients may be generated by using a discrete cosine transform (DCT) method, a discrete Hadamard transform (DHT) method, or a discrete Walsh transform (DWT) method. However, methods of generating the transform coefficients are not limited to the above-mentioned methods. Also, the M×N block may have various sizes such as 32×32, 32×16, 16×32, 16×16, 16×8, 8×16, 8×8, and 4×4. Hereinafter, an 8×8 block will be representatively described for convenience of explanation.

The priority coefficient checking unit 130 checks priority of each transform coefficient at each location of the M×N block with regard to the transform coefficients of the one-dimensional array, which are scanned by the scanning unit 110, and provides information on the priority to the priority correction unit 150. Here, the priority may be determined, for example, based on an absolute value of each transform coefficient. In this case, the priority may be determined by giving a plurality of weights to the transform coefficients in accordance with ranges of their absolute values. For example, a first weight is given to a transform coefficient having an absolute value 0, a second weight is given to a transform coefficient having an absolute value 1, and a third weight is given to a transform coefficient having an absolute value 2 or above. Here, it is preferable that the weights increase from the first weight to the third weight.

As another example, the priority may be determined based on a frequency component of each transform coefficient. That is, a higher priority may be given to a transform coefficient having a low frequency component than a transform coefficient having a high frequency component. For example, if a location of a transform coefficient in a transform block is referred to as (i, j), a fourth weight is given to a transform coefficient of a frequency component at the location (i, j) satisfying i<I1 and j<J1, a fifth weight is given to a transform coefficient of a frequency component at the location (i, j) satisfying i<I2 and j<J2, and a sixth weight is given to other transform coefficients of frequency components.

Alternatively, the priority may be determined by combining the weight given based on an absolute value of each transform coefficient and the weight given based on a frequency component of each transform coefficient.

The priority correction unit 150 includes a weight table on which a weight corresponding to the priority of each transform coefficient at each location of the M×N block is recorded, and corrects a weight at each location of the weight table by receiving a weight at each transform coefficient from the priority coefficient checking unit 130. In more detail, weights at all locations of the weight table are corrected by receiving a weight of each transform coefficient and summing the weight and a corresponding weight stored in the weight table.

The scanning order determination unit 170 rearranges the scanning order from a location having a large weight to a location having a small weight based on the weight table corrected by the priority correction unit 150, and the rearranged scanning order is used to scan a subsequent M×N block.

Meanwhile, the image entropy encoding apparatus illustrated in FIG. 1 may operate in picture units as well as transform block units. Here, a picture may be a frame, a field, or a slice. In picture units, a weight corresponding to priority of each transform coefficient is calculated in accordance with a location with regard to all transform blocks of a picture, calculated weights of each transform block are summed, and a scanning order is determined based on total weights. The scanning order is used to encode a subsequent picture. As such, when a scanning order of a picture is determined, all blocks included in a picture are scanned in the same scanning order. Meanwhile, this scanning order may also be applied to a current picture. In this case, information on the scanning order is recorded on a header region and has to be transmitted through a bitstream. Alternatively, a plurality of scanning orders are previously prepared in accordance with different priority characteristics such as frequency components or absolute values of transform coefficients and then one of the scanning orders is determined and selectively used in block units.

FIG. 2 is a structural block diagram of an image entropy decoding apparatus according to an embodiment of the present invention. The image entropy decoding apparatus illustrated in FIG. 2 includes an inverse scanning unit 210, a priority coefficient checking unit 230, a priority correction unit 250, and an inverse scanning order determination unit 270. Here, the inverse scanning unit 210, the priority coefficient checking unit 230, the priority correction unit 250, and the inverse scanning order determination unit 270 may be implemented as at least one processor.

Referring to FIG. 2, the inverse scanning unit 210 inversely scans current transform coefficients of a 1×MN one-dimensional array in accordance with an inverse scanning order determined by the inverse scanning order determination unit 270, with reference to previous 1×MN one-dimensional arrays, so as to generate transform coefficients of an M×N block. The transform coefficients generated in the M×N block are used to perform inverse quantization or inverse transform. Basically, the priority coefficient checking unit 230 checks priority of each transform coefficient by using the same method as the priority coefficient checking unit 130 illustrated in FIG. 1. The priority correction unit 250 includes a weight table on Which a weight corresponding to the priority of each transform coefficient at each location of the M×N block is recorded, and corrects a weight at each location of the weight table by receiving a weight of each transform coefficient from the priority coefficient checking unit 230.

The inverse scanning order determination unit 270 determines the inverse scanning order from a location having a large weight to a location having a small weight, that is, a mapping correlation of the M×N block with regard to the 1×MN one-dimensional array, based on the weight table corrected by the priority correction unit 250, and the determined inverse scanning order is used to inversely scan a subsequent 1×MN one-dimensional array.

According to embodiments of the image entropy encoding apparatus illustrated in FIG. 1 and the image entropy encoding apparatus illustrated in FIG. 2, by scanning transform coefficients of an M×N block from a transform coefficient having the highest priority to a transform coefficient having the lowest priority, transform coefficients have a value 0 from a certain location of a 1×MN one-dimensional array and thus entropy coding efficiency may be improved. Also, a scanning pattern is determined adaptively to statistical characteristics of a given image or a residual image after prediction and thus uniform improvement of a compression rate may be guaranteed in spite of various characteristics of images.

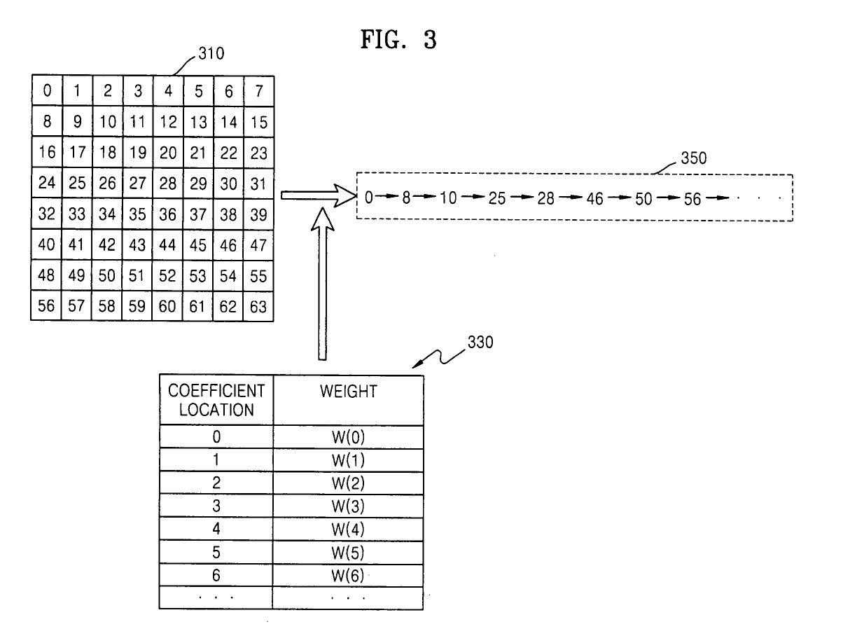

FIG. 3 is a diagram for describing operation of the scanning order determination unit 170 illustrated in FIG. 1, according to an embodiment of the present invention.

Referring to FIG. 3, the scanning order determination unit 170 determines a scanning order by using a weight W(i) (here, i is a location in a transform block) representing priority of at each location of an input M×N block. In more detail, the scanning order is determined in accordance with a size order of weights at corresponding locations of an 8×8 block, which are recorded on a weight table 330 that is updated by using previous 8×8 blocks. A current 8×8 block 310 is scanned from a location having the largest weight to a location having a smallest weight in accordance with the determined scanning order so as to generate transform coefficients 350 in a 1×64 one-dimensional array. Here, if a plurality of transform coefficients have the same weight, a transform coefficient at a front location of an 8×8 block may be scanned first. Meanwhile, the inverse scanning order determination unit 270 illustrated in FIG. 2 may operate based on a similar principal. That is, the transform coefficients 350 in the 1×64 one-dimensional array is received so as to generate an 8×8 block. In more detail, a location of each of the transform coefficients 350 in the 1×64 one-dimensional array is read in accordance with a size order of weights of the weight table 330 and a transform coefficient may be input to a corresponding location.

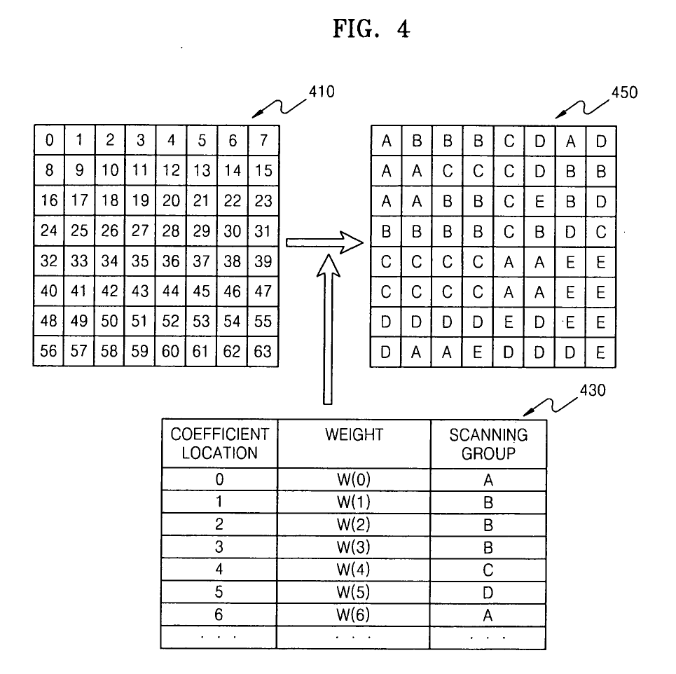

FIG. 4 is a diagram for describing operation of the scanning order determination unit 170 illustrated in FIG. 1, according to another embodiment of the present invention.

Referring to FIG. 4, the scanning order determination unit 170 determines a scanning order in accordance with priority at each location of an M×N block. However, the scanning order is not rearranged in accordance with weights. Instead, the M×N block is divided into a plurality of scanning groups in accordance with ranges of the weights, locations of transform coefficients are grouped in accordance with the scanning groups, and the scanning order is determined from a scanning group having the largest threshold value to a scanning group having the smallest threshold value. For example, a location (i) is grouped into a scanning group A if a weight W(i) at the location (i) is larger than a first threshold value Ta, and a location (i) is grouped into a scanning group B if a weight W(i) at the location (i) is larger than a second threshold value Tb and is smaller than the first threshold value Ta. In this manner, scanning groups C, D, and E may be grouped by using third and fourth threshold values Tc and Td. In this case, the scanning order is determined from the scanning group A to the scanning group E. In more detail, each location of an 8×8 block is grouped into a scanning group by using at least one threshold value and a weight of a transform coefficient at each location of previous 8×8 blocks, and the scanning group is recorded on a weight table 430. Each location of a current 8×8 block 410 is grouped in accordance with scanning groups recorded on the weight table 430 so as to generate a grouped 8×8 block 540 that is grouped into a plurality of scanning groups. The scanning order is ultimately determined so as to correspond to the scanning groups and weights in each scanning group. A scanning order of one scanning group is determined by using a basic raster scanning pattern. That is, a top line is scanned from the left to the right, and then a second top line is scanned from the left to the right, and so on. Meanwhile, if a plurality of transform coefficients in the same group have the same weight, a transform coefficient at a front location of an 8×8 block may be scanned first. Meanwhile, the inverse scanning order determination unit 270 illustrated in FIG. 2 may operate based on a similar principal.

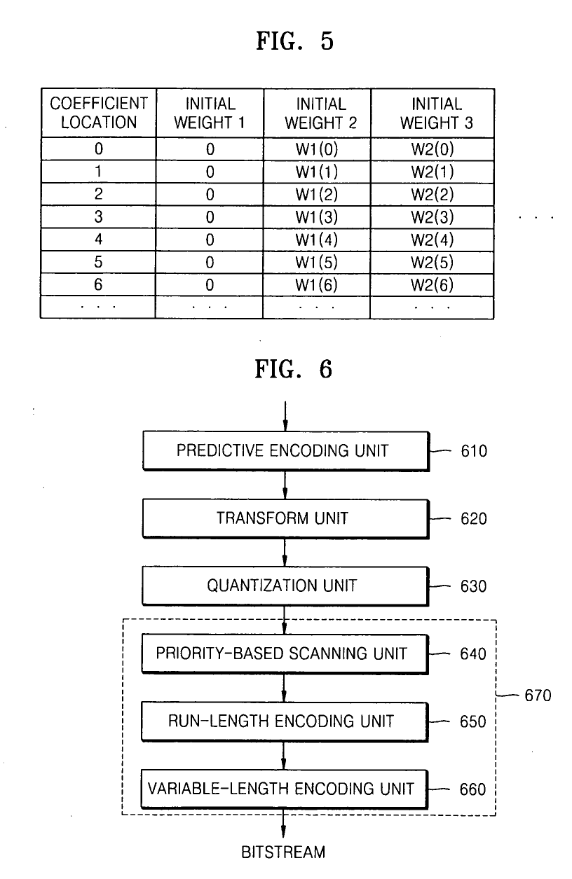

FIG. 5 is a table for describing a method of setting initial weights to be used by the priority correction unit 150 illustrated in FIG. 1 or the priority correction unit 250 illustrated in FIG. 2.

Referring to FIG. 5, the initial weights may be determined by default or by selecting one of various values such as ‘0’, ‘W1’, and ‘W2’ in accordance with image characteristics. An initial scanning pattern may be determined in accordance with the initial weights. For example, the initial weights at all locations of an M×N block are set to have a value ‘0’, initial scanning is performed based on a raster scanning pattern in which scanning is performed in a location order of transform coefficients. Meanwhile, the initial weights may be set so that the initial scanning pattern has a zigzag scanning pattern. In this case, the initial weights at all locations of the M×N block are set so that the initial weights are getting reduced in an order of the zigzag scanning pattern, and the set initial weights are stored in a weight table. Alternatively, priority of each transform coefficient is previously found by checking the image characteristics, weights are given in an order of the priority, and the given weights may be used as the initial weights. If one or more initial weights are selectively used, information on the used initial weights is included in a bitstream so as to be transmitted. The information on the initial weights may be transmitted, for example, in group of pictures (GOP) units, picture units, frame units, slice units, or macroblock units in a case of a video image and, for example, in group of blocks (GOB) units in a case of a still image. If the initial weights are input to the priority correction unit 150 or the priority correction unit 250 in certain units, weights at all locations of the M×N block are initialized so as to correspond to the initial weights.

FIG. 6 is a structural block diagram of an image encoding apparatus according to an embodiment of the present invention. The image encoding apparatus illustrated in FIG. 6 includes a prediction encoding unit 610, a transform unit 620, a quantization unit 630, and an entropy encoding unit 670. Here, the entropy encoding unit 670 includes a priority-based scanning unit 640, a run-length encoding unit 650, and a variable-length encoding unit 660. The priority-based scanning unit 640 may have the configuration illustrated in FIG. 1. Meanwhile, the prediction encoding unit 610, the transform unit 620, the quantization unit 630, and the entropy encoding unit 670 may be implemented as at least one processor.

Referring to FIG. 6, the prediction encoding unit 610 performs temporal/spatial prediction encoding on an input image so as to generate residual data. Here, the input image may be any one of a still image and a video image.

The transform unit 620 transforms the residual data so as to generate transform coefficients in M×N block units. The quantization unit 630 quantizes the transform coefficients in M×N block units.

The entropy encoding unit 670 determines a scanning order based on priority at each location of an M×N block, scans transform coefficients of a quantized M×N block in the determined scanning order, and generates transform coefficients of a 1×MN one-dimensional array. The transform coefficients of the 1×MN one-dimensional array are run-length encoded so as to generate run-length symbols, and the run-length symbols are variable-length encoded so as to be mapped to codewords. Accordingly, a bitstream is generated.

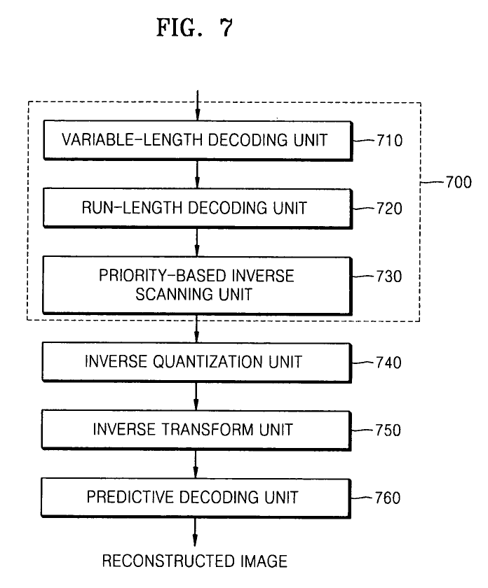

FIG. 7 is a structural block diagram of an image decoding apparatus according to an embodiment of the present invention. The image decoding apparatus illustrated in FIG. 7 includes an entropy decoding unit 700, an inverse quantization unit 740, an inverse transform unit 750, and a prediction decoding unit 760. Here, the entropy decoding unit 700 includes a variable-length decoding unit 710, a run-length decoding unit 720, and a priority-based inverse scanning unit 730. The priority-based inverse scanning unit 730 may have the configuration illustrated in FIG. 2. Meanwhile, the entropy decoding unit 700, the inverse quantization unit 740, the inverse transform unit 750, and the prediction decoding unit 760 may be implemented as at least one processor.

Referring to FIG. 7, the entropy decoding unit 700 performs variable-length decoding on a bitstream so as to restore run-length symbols, and performs run-length decoding on the restored run-length symbols so as to restore quantized transform coefficients of a 1×MN one-dimensional array. An inverse scanning order is determined based on priority at each location of an M×N block and the quantized transform coefficients of the 1×MN one-dimensional array are inversely scanned in the determined inverse scanning order. Accordingly, quantized transform coefficients of the M×N block are generated.

The inverse quantization unit 740 inversely quantizes the quantized transform coefficients of the M×N block so as to restore transform coefficients of the M×N block. The inverse transform unit 750 inversely transforms the transform coefficients so as to restore residual data. The prediction decoding unit 760 performs temporal/spatial prediction decoding on the residual data so as to generate a reconstructed image.

Examples of the image encoding apparatus illustrated in FIG. 6 and the image decoding apparatus illustrated in FIG. 7, excepting the entropy encoding unit 670 illustrated in FIG. 6 and the entropy decoding unit 700 illustrated in FIG. 7, are H.264, MPEG-2, and MPEG-4 codecs which are general image codecs adopting motion compensation technology.

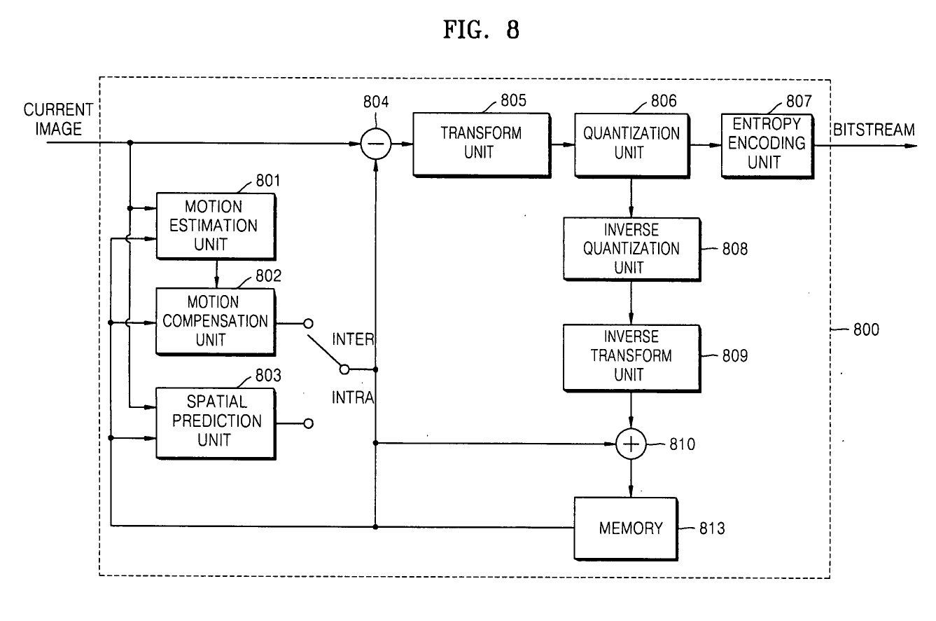

FIG. 8 is a structural block diagram of an image encoding apparatus according to another embodiment of the present invention. The image encoding apparatus illustrated in FIG. 8 includes a motion estimation unit 801, a motion compensation unit 802, a spatial prediction unit 803, a subtracter 804, a transform unit 805, a quantization unit 806, an entropy encoding unit 807, an inverse quantization unit 808, an inverse transform unit 809, an adder 810, and a memory 813. Here, the entropy encoding unit 807 may be implemented as the priority-based scanning unit 640, the run-length encoding unit 650, and the variable-length encoding unit 660 illustrated in FIG. 6. Meanwhile, the motion estimation unit 801, the motion compensation unit 802, the spatial prediction unit 803, the subtracter 804, the inverse quantization unit 808, the inverse transform unit 809, the adder 810, and the memory 813 are regarded to correspond to the prediction encoding unit 610 illustrated in FIG. 6.

Referring to FIG. 8, the motion estimation unit 801 estimates motion of a current image included in an image sequence, based on at least one reference image stored in the memory 813. In more detail, the motion estimation unit 801 determines a block of the reference image, which mostly matches each inter-mode block of the current image, and calculates a motion vector representing displacement between the determined block of the reference image and the inter-mode block of the current image.

The motion compensation unit 802 generates a prediction image of the current image from at least one reference image by using motion estimation results of the motion estimation unit 801. In more detail, the motion compensation unit 802 generates the prediction image of the current image by using blocks of at least one reference block, which are indicated by motion vectors of inter-mode blocks of the current image, which are calculated by the motion estimation unit 801.

The spatial prediction unit 803 predicts each intra-mode block of the current image from neighboring blocks of the intra-mode block, which are included in at least one reference image stored in the memory 813, so as to generate a prediction image of the current image.

The subtracter 804 subtracts the prediction image generated by the motion compensation unit 802 or the spatial prediction unit 803 from the current image so as to generate a residual image between the current image and the prediction image.

The transform unit 805 transforms the residual image generated by the subtracter 804 from the space domain to the frequency domain. For example, the transform unit 805 may transform the residual image generated by the subtracter 804 from the space domain to the frequency domain by using a DHT method or a DCT method. The quantization unit 806 quantizes transform results of the transform unit 805. In more detail, the quantization unit 806 divides the transform results that are frequency components, by a quantization step-size and approximates the divided frequency components to integers.

The entropy encoding unit 807 performs entropy encoding on quantization results of the quantization unit 806 so as to generate a bitstream. For example, the entropy encoding unit 807 may perform the entropy encoding on the quantization results of the quantization unit 806 by using a context-adaptive variable-length coding (CAVLC) method or a context-adaptive binary arithmetic coding (CABAC) method. In particular, in addition to the quantization results of the quantization unit 806, the entropy encoding unit 807 also performs the entropy encoding on information required for decoding, such as index information of a reference image that is used to perform temporal prediction, motion vector information, and location information of blocks of a reconstructed image that is used to perform spatial prediction.

The inverse quantization unit 808 inversely quantizes the quantization results of the quantization unit 806. In more detail, the inverse quantization unit 808 restores the frequency components by multiplying the integers approximated by the quantization unit 806, by the quantization step-size. The inverse transform unit 809 transforms inversely transform results of the inverse quantization unit 808, which are frequency components, from the frequency domain to the space domain, so as to restore the residual image between the current image and the prediction image. The adder 810 adds the residual image restored by the inverse transform unit 809 to the prediction image generated by the motion compensation unit 802 or the spatial prediction unit 803, so as to generate the reconstructed image of the current image and to store the reconstructed image in the memory 813. The reconstructed image is used as a reference image of subsequent or previous images of the current image.

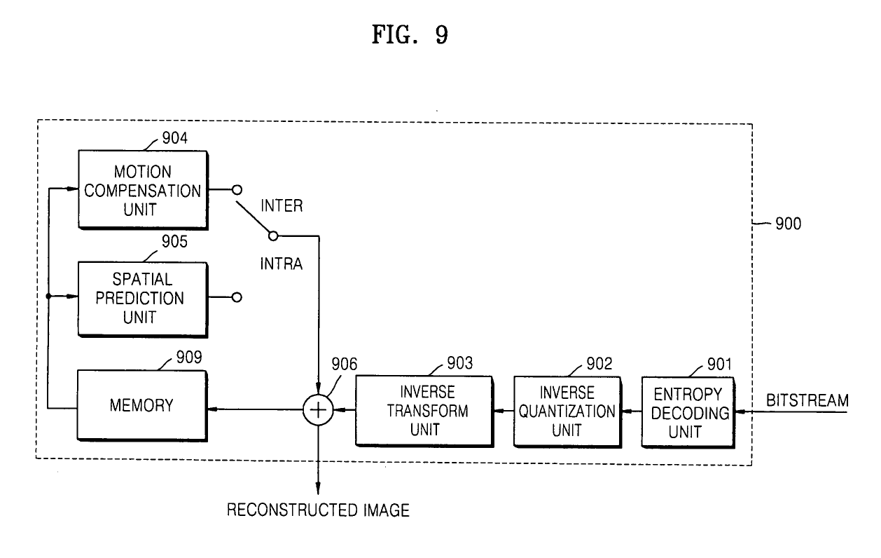

FIG. 9 is a structural block diagram of an image decoding apparatus according to another embodiment of the present invention. The image decoding apparatus illustrated in FIG. 9 includes an entropy decoding unit 901, an inverse quantization unit 902, an inverse transform unit 903, a motion compensation unit 904, a spatial prediction unit 905, an adder 906, and a memory 909. Here, the entropy decoding unit 901 may be implemented as the variable-length decoding unit 710, the run-length decoding unit 720, and the priority-based inverse scanning unit 730 illustrated in FIG. 7. Meanwhile, the motion compensation unit 904, the spatial prediction unit 905, the adder 906, and the memory 909 are regarded to correspond to the prediction decoding unit 760 illustrated in FIG. 7. Image restoration operation of the image decoding apparatus illustrated in FIG. 9 is the same as the image restoration operation of the image encoding apparatus illustrated in FIG. 8. Thus, although omitted, descriptions which are made above with reference to the image encoding apparatus illustrated in FIG. 8 are also applied to the image decoding apparatus illustrated in FIG. 9.

Referring to FIG. 9, the entropy decoding unit 901 performs entropy decoding on a bitstream generated by the image encoding apparatus illustrated in FIG. 8, so as to restore, for example, information required for decoding and integers of image data. The inverse quantization unit 902 inversely quantizes the integers restored by the entropy decoding unit 901 so as to restore frequency components. The inverse conversion unit 903 transforms the frequency components restored by the inverse quantization unit 902 from the frequency domain to the time domain so as to restore a residual image between a current image and a prediction image.

The motion compensation unit 904 generates a prediction image of the current image from at least one reference image stored in the memory 909 by using motion vectors. The spatial prediction unit 905 predicts each intra-mode block of the current image from neighboring blocks of the intra-mode block, which are included in at least one reference image stored in the memory 909, so as to generate a prediction image of the current image. The adder 906 adds the residual image restored by the inverse transform unit 903 to the prediction image generated by the motion compensation unit 904 or the spatial prediction unit 905, so as to generate a reconstructed image of the current image.

In addition to the above described embodiments, embodiments of the present invention can also be implemented through computer readable code/instructions in/on a medium, e.g., a computer readable medium, to control at least one processing element to implement any above described embodiment.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), for example. Thus, the medium may be such a defined and measurable structure, such as a device supporting a bitstream, for example, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

While aspects of the present invention has been particularly shown and described with reference to differing embodiments thereof, it should be understood that these exemplary embodiments should be considered in a descriptive sense only and not for purposes of limitation. Descriptions of features or aspects within each embodiment should typically be considered as available for other similar features or aspects in the remaining embodiments.

Thus, although a few embodiments have been shown and described, it would be appreciated by those skilled in the art that changes may be made in these embodiments without departing from the principles and spirit of the invention, the scope of which is defined in the claims and their equivalents.

What is claimed is:

1. An image entropy encoding apparatus comprising:
a scanning unit to scan transform coefficients of a transform block in accordance with a scanning order so as to arrange the transform coefficients in a one-dimensional array;
a priority coefficient checking unit to check priority of the transform coefficients of the one-dimensional array;
a priority correction unit to correct weights of the transform coefficients in accordance with locations, by using the priority checked by the priority coefficient checking unit; and
a scanning order determination unit to determine the scanning order from a location having a large weight to a location having a small weight in the transform block, based on the corrected weights.

2. The image entropy encoding apparatus of claim 1, wherein the priority coefficient checking unit determines the priority by giving a weight based on an absolute value of each transform coefficient.

3. The image entropy encoding apparatus of claim 1, wherein the priority coefficient checking unit determines the priority by giving a weight based on a frequency component of each transform coefficient.

4. The image entropy encoding apparatus of claim 1, wherein the scanning order determination unit groups a location of each transform coefficient of the transform block into one of a plurality of scanning groups by using the corrected weights and a plurality of threshold values, and determines the scanning order of the scanning groups from a scanning group having a large weight to a scanning group having a small weight.

5. The image entropy encoding apparatus of claim 4, wherein, if a plurality of locations in the same scanning group have the same weight, transform coefficients at the locations are scanned in accordance with a raster scanning order.

6. The image entropy encoding apparatus of claim 1, wherein the priority correction unit has initial weights, and information on the initial weights is transmitted in a bitstream.

7. The image entropy encoding apparatus of claim 6, wherein the information on the initial weights is transmitted in one of sequence units, picture units, frame units, and block units.

8. An image entropy decoding apparatus comprising:
an inverse scanning unit to inversely scan transform coefficients of a one-dimensional array, which are restored from a bitstream, in accordance with an inverse scanning order so as to generate quantized transform coefficients of a transform block;
a priority coefficient checking unit to check priority of the quantized transform coefficients of the transform block;
a priority correction unit to correct weights of the transform coefficients in accordance with locations, by using the priority checked by the priority coefficient checking unit; and
an inverse scanning order determination unit to determine the inverse scanning order from a location having a large weight to a location having a small weight in the transform block, based on the corrected weights.

9. The image entropy decoding apparatus of claim 8, wherein the priority coefficient checking unit determines the priority by giving a weight based on an absolute value of each transform coefficient.

10. The image entropy decoding apparatus of claim 8, wherein the priority coefficient checking unit determines the priority by giving a weight based on a frequency component of each transform coefficient.

11. The image entropy decoding apparatus of claim 8, wherein the inverse scanning order determination unit groups a location of each transform coefficient of the transform block into one of a plurality of scanning groups by using the corrected weights and a plurality of threshold values, and determines the inverse scanning order of the scanning groups from a scanning group having a large weight to a scanning group having a small weight.

12. The image entropy decoding apparatus of claim 11, wherein, if a plurality of locations in the same scanning group have the same weight, transform coefficients at the locations are scanned in accordance with a raster scanning order.

13. The image entropy decoding apparatus of claim 8, wherein the priority correction unit has initial weights, and information on the initial weights is transmitted in a bitstream.

14. The image entropy decoding apparatus of claim 13, wherein the information on the initial weights is transmitted in one of sequence units, picture units, frame units, and block units.

15. An image decoding apparatus comprising:
an entropy decoding unit to perform entropy decoding on a bitstream so as to restore quantized transform coefficients of a one-dimensional array, to determine an inverse scanning order based on priority at each location of a transform block, and to inversely scan the quantized transform coefficients of the one-dimensional array in the determined inverse scanning order so as to generate quantized transform coefficients of the transform block;
an inverse quantization unit to inversely quantize the quantized transform coefficients of the transform block so as to restore transform coefficients of the transform block;
an inverse transform unit to inversely transform the transform coefficients of the transform block so as to restore a residual image; and
a prediction decoding unit to perform prediction decoding on the residual image so as to generate a reconstructed image.

16. The image entropy decoding apparatus of claim 15, wherein the entropy decoding unit comprises:
a variable-length decoding unit to perform variable-length decoding on a bitstream so as to restore run-length symbols;
a run-length decoding unit to perform run-length decoding on the run-length symbols so as to restore transform coefficients of the one-dimensional array; and
a priority-based inverse scanning unit to correct weights of a current transform block in accordance with locations from information on priority of transform coefficients of at least one previous transform block, to determine an inverse scanning order of the transform coefficients of the current transform block based on the corrected weights, and to inversely scan the transform coefficients of the one-dimensional array in accordance with the determined inverse scanning order so as to generate the transform coefficients of the current transform block.

17. The image entropy decoding apparatus of claim 16, wherein the priority-based inverse scanning unit groups a location of each transform coefficient of the transform block into one of a plurality of scanning groups by using the corrected weights and a plurality of threshold values, and determines the inverse scanning order of the scanning groups from a scanning group having a large weight to a scanning group having a small weight.

18. The image entropy decoding apparatus of claim 17, wherein, if a plurality of locations in the same scanning group have the same weight, transform coefficients at the locations are inversely scanned in accordance with a raster scanning order.

19. The image entropy decoding apparatus of claim 16, wherein the priority-based inverse scanning unit has initial weights, and information on the initial weights is transmitted in a bitstream.

20. The image entropy decoding apparatus of claim 19, wherein the information on the initial weights is transmitted in one of sequence units, picture units, frame units, and block units.
